(19) United States
(12) Patent Application Publication
(10) Pub. No.: US 2024/0142742 A1
(43) Pub. Date: May 2, 2024

(54) IMAGE SENSOR WITH MULTIPLE LENSES AND ALIGNMENT OF THE MULTIPLE LENSES

(71) Applicant: GoPro, Inc., San Mateo, CA (US)

(72) Inventors: David Thomas Platner, San Francisco, CA (US); Ian Copeland Griggs, San Francisco, CA (US); Jonathan Stern, San Mateo, CA (US); Mahshad Mosayebi, Palo Alto, CA (US)

(21) Appl. No.: 18/384,402

(22) Filed: Oct. 27, 2023

Related U.S. Application Data
(60) Provisional application No. 63/421,729, filed on Nov. 2, 2022.

(51) Int. Cl. G02B 7/02; G03B 17/12

(52) U.S. Cl. CPC G02B 7/021; G02B 7/026; G03B 17/12

(57) ABSTRACT

The present teachings provide an image capture device including an optical system. The optical system includes a rearward lens assembly, a forward lens assembly, and a bias device. The forward lens assembly is axially aligned with the rearward lens assembly along an optical axis. The bias device is located between the rearward lens assembly and the forward lens assembly and is configured to allow the forward lens assembly to move relative to the rearward lens assembly.

### CROSS-REFERENCE TO RELATED APPLICATION(S)

This application claims priority to and the benefit of U.S. Provisional Application Patent Serial No. 63/421,729 filed Nov. 2, 2022, the entire disclosure of which is hereby incorporated by reference.

### TECHNICAL FIELD

This disclosure relates generally to a mounting structure for a camera having an optical system including an integrated sensor and lens assembly and specifically to mounting structures that align multiple lenses relative to one another.

### BACKGROUND

Typical cameras include one or more lenses and one or more image sensors. The image sensor(s) is aligned with the lens(es) so that images may be taken through the lens(es). The image sensor(s) and lens(es) are connected within an image capture device so that alignment of the image sensor(s) and lens(es) is maintained. The image sensor(s) and lens(es) may be connected to a frame or to each other so that alignment is achieved and maintained. These attachments may constrain the size and/or shape of the image sensor(s), the lens(es), or both so that the components may be connected within a body of a camera.

### SUMMARY

Disclosed herein are implementations of a mounting structure (e.g., a bayonet) that connects a lens assembly within an image capture device while aligning the lens assembly with an integrated sensor without the connection interfering with the integrated sensor and the lens assembly.

The present teachings provide an image capture device including an optical system. The optical system includes: a rearward lens assembly, a forward lens assembly, and a bias device. The forward lens assembly is axially aligned with the rearward lens assembly along an optical axis. The bias device is located between the rearward lens assembly and the forward lens assembly and is configured to allow the forward lens assembly to move relative to the rearward lens assembly.

The present teachings provide an image capture device including a forward lens assembly, a rearward lens assembly, and a connector. The forward lens assembly has two or more connector fingers. The rearward lens assembly is aligned with the forward lens assembly along an optical axis. The connector receives all or a portion of the forward lens assembly and all or a portion of the rearward lens assembly. The connector has two or more guides that align with and are configured to receive the two or more connector fingers so that when the two or more connector fingers are inserted into the two or more guides, the forward lens assembly is removably connected to the connector. The forward lens assembly floats within the connector so that the forward lens assembly is movable relative to the rearward lens assembly.

The present teachings provide an image capture device with an optical system. The optical system includes: a forward lens assembly, a forward housing, and a connector. The forward housing has an exterior surface with clocking surfaces. The connector receives all or a portion of the forward lens assembly. The connector includes an interior surface having compression alignment surfaces that form a locked position when the compression alignment surfaces are aligned with the clocking surfaces to create a friction fit that prevents the forward lens assembly from moving relative to the connector.

The present teachings provide an image capture device with a forward lens assembly, a rearward lens assembly, and a forward coupling connector. The rearward lens assembly is axially aligned with the forward lens assembly. The forward coupling connector is located between the forward lens assembly and the rearward lens assembly. The forward coupling connector includes a locking system that removably connects the forward lens assembly to the forward coupling connector by rotating the forward lens assembly into the locking system to connect the forward lens assembly to the forward coupling connector.

The present teachings may further include one or more of the following. The locking system may comprise a rotation portion that contacts a portion of the forward lens assembly to facilitate a connection between the forward lens assembly and the forward coupling connector. The forward lens assembly comprises locking fingers that extend into the locking system to removably connect the forward lens assembly to the forward coupling connector. Locking fingers may extend into the locking system in a first locking direction and then a second locking direction to form a connection between the forward lens assembly and the forward coupling connector. The locking portions may house the locking fingers to removably connect the forward lens assembly and the forward coupling connector.

The present teachings provide an image capture device with a forward lens assembly; a forward coupling connector; a rearward lens assembly; a rearward coupling connector; and a union. The forward coupling connector houses all or a portion of the forward lens assembly. The rearward lens assembly is axially aligned with the forward lens assembly along an optical axis. The rearward coupling connector houses all or a portion of the rearward lens assembly. The union connects the forward coupling connector and the rearward coupling connector together.

The present teachings may further include one or more of the following. The forward coupling connector may include a locking system. The union may permit movement of the forward lens assembly to move relative to the rearward lens assembly. The union may prevent movement of the forward lens assembly and the rearward lens assembly along the optical axis. The union only permits movement that is perpendicular to the optical axis.

Additional teachings are described in further detail below.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial view of the image capture device of FIG. 2C.

FIG. 3 is a block diagram of electronic components of an image capture device.

FIG. 4A is an isometric view of an optical system removed from an image capture device with a portion of a connector cut away.

FIG. 4B is a cross-sectional view of the optical system of FIG. 4A along line IVB-IVB with the bayonet included on the optical system.

FIG. 5A is an isometric view of an optical system removed from an image capture device.

FIG. 5B is a cross-sectional view of the optical system of FIG. 5A along line VB-VB.

FIG. 6A is an isometric view of an optical system removed from an image capture device.

FIG. 6B is an isometric view of the optical system of FIG. 6A with a forward lens removed from the optical system.

FIG. 6C is a cross-sectional view of the optical system of FIG. 6A along line VIC-VIC.

FIG. 6D is an isometric view of a connector of FIGS. 6A-6C.

FIG. 6E is an isometric view of a housing of a rearward lens assembly of FIGS. 6A-6C.

FIG. 6F is an isometric view of a forward lens assembly of FIGS. 6A-6C.

FIG. 7A is an isometric view of an optical system removed from an image capture device with a forward lens removed the optical system.

FIG. 7B is a top cross-sectional view the optical system of FIG. 7A along line VIIBC-VIIBC showing a connector and a forward housing in a locked position.

FIG. 7C is a top cross-sectional view of the optical system of FIG. 7A along line VIIBC-VIIBC showing a connector and a forward housing in an unlocked position.

FIG. 8A is a bottom isometric view of an optical system removed from an image capture device.

FIG. 8B is a cross-sectional view of the optical system of FIG. 8A along line VIIIB-VIIIB.

FIG. 8C is a bottom isometric view of a lens module of FIG. 8A.

FIG. 8D is an isometric view of a forward coupling connector of FIG. 8A.

FIG. 8E is an isometric view of a union of FIG. 8A.

### DETAILED DESCRIPTION

As technology advances, consumers have increasing demands for more computing power, more options, or additional functionality in electronic devices. These increases in computing power or functionality may result in additional components being added into an image capture device, an increase in size of an integrated sensor for the image capture device, or both. These additional components or larger integrated sensors reduce the amount of packaging space available to locate components relative to each other. For example, a larger integrated sensor may be more difficult to align with a lens assembly then a smaller integrated lens assembly as the line of sight may be obscured. Thus, the present teachings provide a fastening scheme to connect an integrated sensor and lens assembly (ISLA) within an image capture device where fastening occurs irrespective of packaging space within the image capture device or a size of an integrated sensor. The fastening scheme taught herein seeks to avoid a connection around the integrated sensor such that the integrated sensor may be moved, enlarged, changed, or a combination thereof without interfering with installation of the ISLA.

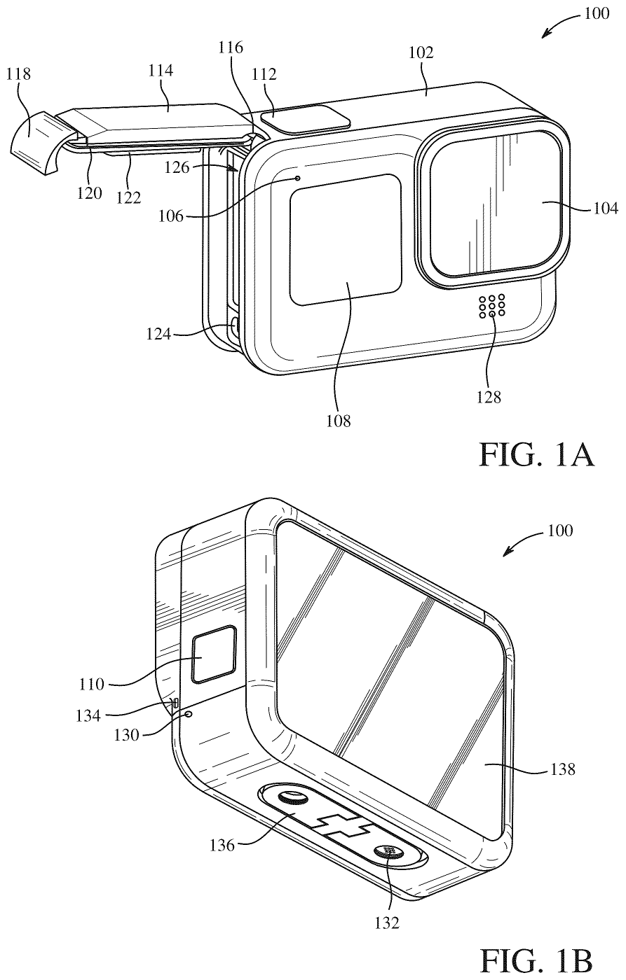

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor (e.g., integrated sensor) internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors (e.g., integrated sensors), such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

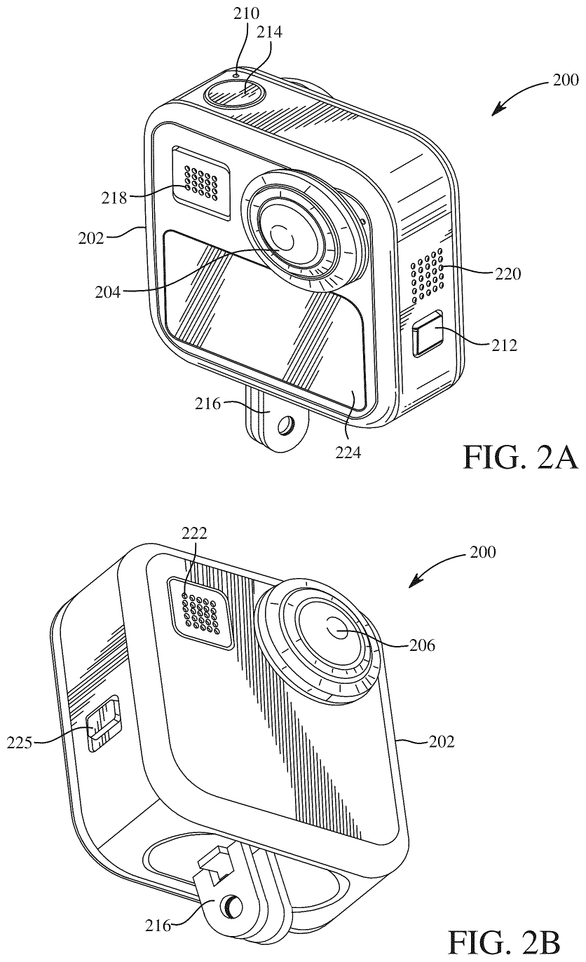

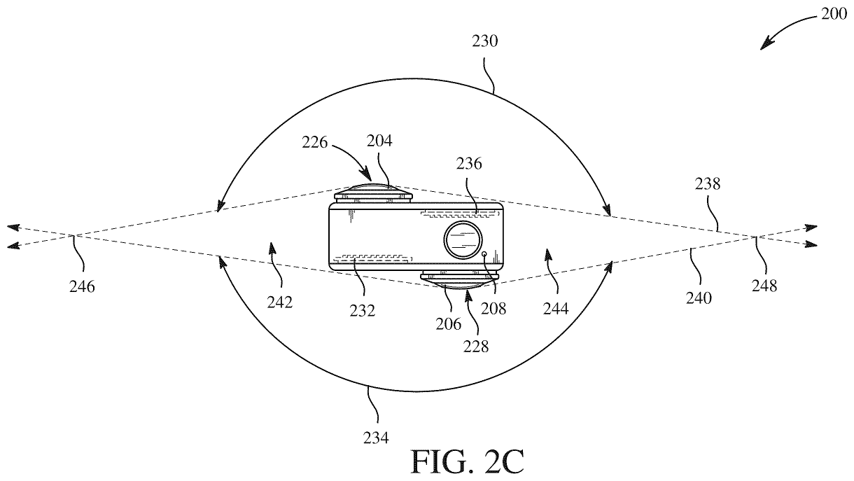

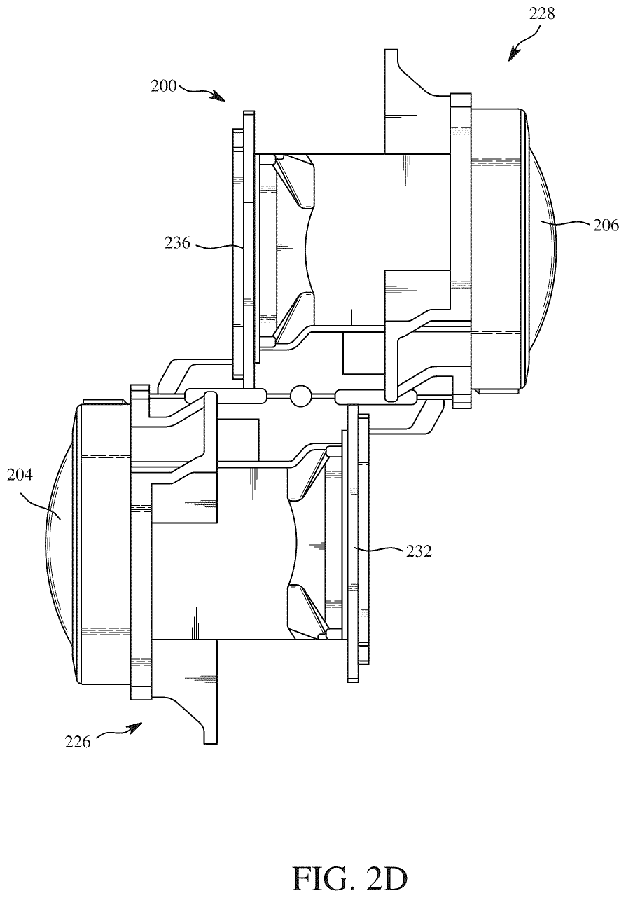

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

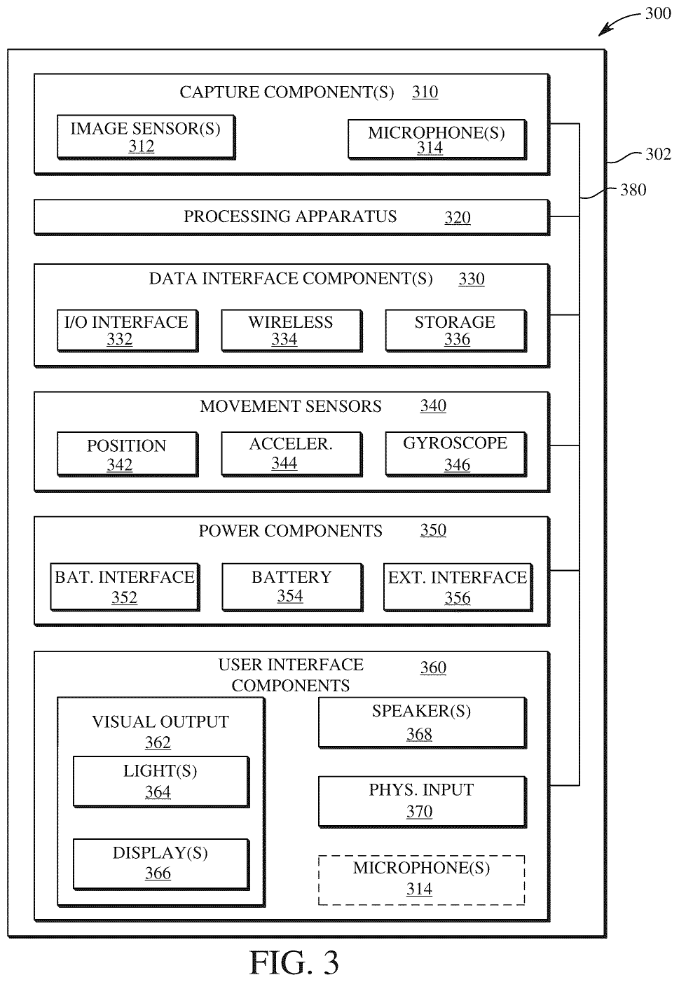

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

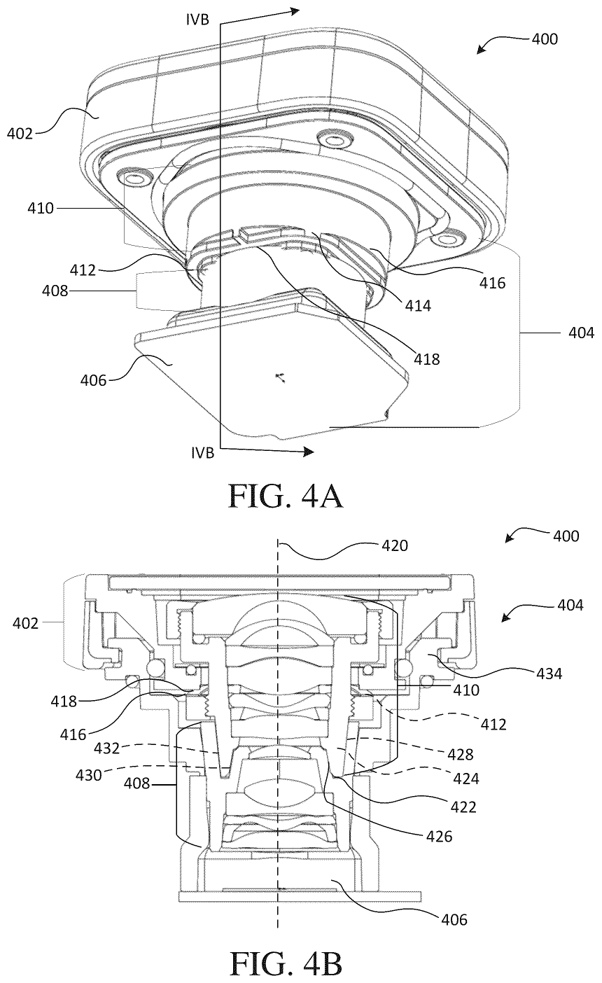

FIG. 4 is an isometric view of an optical system 400. The optical system 400 can be used as a part of the image capture devices 100, 200 of FIGS. 1A and 2A-2B to take images or videos. The optical system 400 is located within the image capture device so that the image capture device protects the optical system 400. The optical system 400 includes a lens module 402 located in front of an integrated sensor and lens assembly (ISLA) 404. An integrated sensor 406 is located behind and connected to a rearward lens assembly 408. The integrated sensor 406 may be any image sensor discussed herein that is capable of supporting detection, capture, recording, and storage of an image, video, or both. A forward lens assembly 410 is located between the rearward lens assembly 408 and the lens module 402. The forward lens assembly 408 and the rearward lens assembly 410 are spaced apart by a bias device 412.

The bias device 412 may permit the rearward lens assembly 408 to move relative to the forward lens assembly 410. The bias device 412 is exposed through a wall of the optical system 400. The bias device 412 may create an axial force so that the rearward lens assembly 408 and the forward lens assembly 410 are pushed away from one another and are not in direct contact. The bias device 412 may be in direct contact with the forward lens assembly 410. The bias device 412 may generate an axial force on the forward lens assembly 410 that moves the forward lens assembly 410 into contact with the rearward lens assembly 408. The bias device 412 may bias the forward lens assembly 410 away from the lens module 402 so that the forward lens assembly 410 floats relative to the lens module 402. The bias device 412 may permit the forward lens assembly 410 to move relative to the rearward lens assembly 408. For example, if the optical system 400 is dropped or banged the bias device 412 permits the forward lens assembly 410 to move relative to the rearward lens assembly 408, the lens module 402, or both. The bias device 412 may bias the forward lens assembly 410 away from the lens module 402 so that the lens module 402 and the forward lens assembly 410 are not directly in contact. The bias device 412 may be or include rubber, an elastomer, plastic, a polymer, metal, spring steel, or a combination thereof. The bias device 412 may be a spring, a tension spring, a wave washer, a wave spring, or a combination thereof. The bias device 412 may only bias along an axis (e.g., an optical axis or in the z-direction). The bias device 412 may be entirely coplanar and be compressible to form a bias force upon being compressed. The bias device 412 may have a wave shape with peaks and valleys. The peaks may be in a first plane and the valleys may be in a second plane. The bias device 412 may contact protrusions 414 on a shoulder 416, the shoulder 416, or both of the forward lens assembly 410.

The protrusions 414 may extend outward from the shoulder 416 of the forward lens assembly 410. The protrusions 414 may extend axially towards the rearward lens assembly 408. The protrusions 414 may contact the bias device 412 to hold the bias device 412 in place or create a minimum amount of bias along the axis of the optical system. The protrusions 414 may prevent the bias device 412 from rotating. The protrusions 414 may extend into a valley of the bias device 412 so that the bias device 412 is constrained between the forward lens assembly 410 and the rearward lens assembly 408. The protrusions 414 may contact a peak so that when the optical system 400 is assembled the bias device 412 generates a pre-determined amount of axial force. The protrusions 414 may be intermittently spaced along the shoulder 416 of the forward lens assembly 410. The protrusions 414 may be spaced to align with the peaks, the valleys, or both. The protrusions 414 may have varying lengths depending on a portion of the bias device 412 the protrusions 414 are aligned. The protrusions 414 may constrain the bias device 412 between a shoulder 416 on the forward lens assembly 410 and a forward shoulder 418 on the lens module 402.

The shoulder 416 may be a planar portion of the forward lens assembly 410. The forward shoulder 418 may be a planar portion of the lens module 402. The shoulder 416 and the forward shoulder 418 (hereinafter shoulders) may be in opposing alignment or spaced apart. The shoulder 416 may be a contact portion of the forward lens assembly 410 so that when the bias device 412 contacts the shoulder 416 the forward lens assembly 410 is axially moved or is axially held in a position. The forward shoulder 418 may be a contact portion of the lens module 402 so that when the bias device 412 contacts the forward shoulder 418, the forward lens assembly 410 is axially moved or is axially held in a position relative to the rearward lens assembly 408. The shoulders 416 and 418 are parallel to one another. The shoulders 416 and 418 may constrain a bias device 412 therebetween so that the rearward lens assembly 408 and the forward lens assembly 410 are movable relative to one another.

FIG. 4B illustrates a cross-sectional view of the optical system 400 of FIG. 4A along line IVB-IVB. The optical system 400 includes a lens module 402 that forms a forward most portion of the optical system 400. The lens module 402 covers an integrated sensor and lens assembly (ISLA) 404. The ISLA 404 is made up of an integrated sensor 406, rearward lens assembly 408, and a forward lens assembly 410. A bias device 412 is located between the rearward lens assembly 408 and the forward lens assembly 410.

The bias device 412 is in contact with a protrusion 414 of the forward lens assembly 410, a shoulder 416 of the forward lens assembly 410, or both. The bias device 412 is in contact with a rear of the shoulder 416 of the lens module 402. The rearward lens assembly 408 and the forward lens assembly 410 are movable along an optical axis 420 by the bias device 412 or the bias device 412 being biased. The optical axis 420 extends from the integrated sensor 406 through the rearward lens assembly 408 and the forward lens assembly 410. The rearward lens assembly 408 includes a groove 422 and the forward lens assembly 410 includes a tongue 424 that extends into the groove 422 when the bias device 412 exerts an axial force on the forward lens assembly 410 so that the tongue 424 is seated within the groove 422.

The groove 422 is an annular ring with an inner wall 426 and an outer wall 428. The inner wall 426 and the outer wall 428 converge as the inner wall 426 and the outer wall 428 extend towards a bottom of the groove 422. The groove 422 may be tapered. The groove 422 may align the forward lens assembly 410 relative to the rearward lens assembly 408, along the optical axis 420, or both. The groove 422 may prevent radial movement, tipping, mis-alignment, or a combination thereof of the forward lens assembly 410 relative to the rearward lens assembly 408. The groove 422 may be sufficiently deep so that when the tongue 424 is seated within the groove 422 the forward lens assembly 410 will be axially aligned with the rearward lens assembly 408. The groove 422 may have a depth of about 1 mm or more, 2 mm or more, 3 mm or more, 2 cm or less, 1 cm or less, or 7 mm or less. The groove 422 may be sufficiently deep so that when the tongue 424 is inserted into the groove 422 a connection is formed between the forward lens assembly 410 and the rearward lens assembly 408.

The tongue 424 may be complementary in shape and size to the groove 422. The tongue 424 may have outer walls that converge towards one another. The tongue 424 may have an inside wall 430 and an outside wall 432. The inside wall 430 contacts an inner wall 426 and the outside wall 432 contacts an outer wall 428 when the tongue 424 is fully seated within the groove 422. The bias device 412 biases the tongue 424 of the forward lens assembly 408 into the groove 422 of the rearward lens assembly 410. The bias device 412 may permit some axial movement of the tongue 424 within the groove 422. For example, if the optical system is dropped the bias device 412 may bias so that some movement of the forward lens assembly 410 is permitted to prevent damage to the forward lens assembly 410, the rearward lens assembly 408, or both. The bias device 412 may bias the tongue 424 fully into the groove 422. The bias device 412 may allow movement equal to or less than a thickness of the bias device 412. The bias device 412 may allow the forward lens assembly 410 to float relative to the rearward lens assembly 408. The movement may have a distance of about 0.25 mm or more, about 0.5 mm or more, about 0.75 mm or more, or about 1 mm or more. The movement may have a distance of about 3 mm or less, about 2 mm or less, or about 1.5 mm or less. The movement may be a distance the forward lens assembly 410 may move relative to the lens module 402 is a direction away from the rearward lens assembly 408.

A connector 434 may extend from the rearward lens assembly 408 outward so that the lens module 402 is connected forward of the forward lens assembly 410. The connector 434 may form a removable connection with the lens module 402 so that the lens module 402 may be removed. The connector 434 may form a connection by a press-fit, twist and lock, fasteners, threads, or a combination thereof. The connector 434 may be a bayonet. The connector 434 may allow the lens module 402 to be removed so that the forward lens assembly 410 may be inserted into the optical system 400 and/or removed from the optical system 400. The connector 434 may extend around the forward lens assembly 410 so that the forward lens assembly 410 and the lens module 402 are isolated relative to one another. The forward lens assembly 410 may only be connected to the rearward lens assembly 408. For example, if a force is applied to the optical system 400, such as by being dropped, the force will be directed to the lens module 402 and the connector 434 without the force being directly applied to the forward lens assembly 410. The connector 434 may prevent axial movement of the lens module 402 so that the bias device 412 biases the forward lens assembly 410 relative to the rearward lens assembly 408.

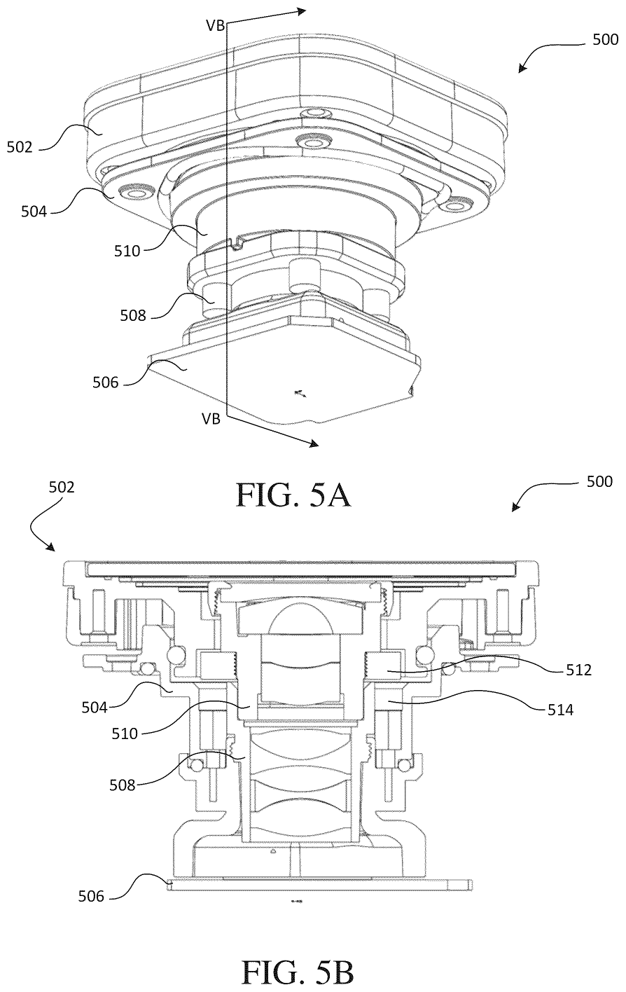

FIG. 5A is an isometric view of an optical system 500. The optical system 500 includes a lens module 502 forming a forward end. The lens module 502 is connected within the optical system 500 via a connector 504. A rearward end of the optical system 500 includes an integrated sensor 506. The integrated sensor 506 is connected to a rearward lens assembly 508. A forward lens assembly 510 is located between the lens module 502 and the rearward lens assembly 508 with the connector 504 extending around the forward lens assembly 510.

FIG. 5B is a cross-sectional view of the optical system 500 of FIG. 5A along line VB-VB. The lens module 502 may be removable and changeable. The lens module 502 may include an outer most lens that forms a forward most end of the optical system 500. The optical system 500 has a lens module 502 at a forward end that is connected to the connector 504.

The connector 504 may releasably connect the lens module 502 to the optical system 500 or an image capture device 100, 200. The connector 504 may form a connection with the lens module 502 by threads, fasteners, twist and lock, or a combination thereof. The connector 504 may include one or more parts. The connector 504 may form an outside of the optical system 500. The connector 504 may be directly or indirectly connected to the integrated sensor 506.

The integrated sensor 506 may capture images. The integrated sensor 506 may be aligned along an optical axis. The integrated sensor 506, rearward lens assembly 508, forward lens assembly 510, and lens module 502 are all aligned along an optical axis and connected to form the optical system 500. The integrated sensor 506 may be connected to a rear side of a rearward lens assembly 508.

The rearward lens assembly 508 is a first set of lenses. The rearward lens assembly 508 is aligned with the integrated sensor 506. The rearward lens assembly 508 may be connected to the connector 504 (e.g., a direct connection). The rearward lens assembly 508 may include one or more, two or more, three or more, or four or more lenses. The rearward lens assembly 508 may be axially aligned with a forward lens assembly 510.

The forward lens assembly 510 may be aligned along the optical axis. The forward lens assembly 510 may be axially aligned with the integrated sensor 506 and the lens module 502. The forward lens assembly 510 may include one or more lenses, two or more lenses, or three or more lenses. The lenses of the forward lens assembly 510, the rearward lens assembly 508, or both may all be the same, all may be different, a combination of lens types, or some the same and some different. The forward lens assembly 510 may be free of any connection with the connector 504, the lens module 502, or both. The forward lens assembly 510 may contact the rearward lens assembly 508 at a rear end but float so that the forward lens assembly 510 may move axially away from the rearward lens assembly 508, the lens module 502, or both. The forward lens assembly 510 may include a forward bias device 512 and the rearward lens assembly 508 may include a rearward bias device 514.

The forward bias device 512 and the rearward bias device 514 may be substantially a same device. The forward bias device 512 may bias the forward lens assembly 510 in a first direction (e.g., forward direction), a second direction (e.g., a rearward direction), or both. The forward bias device 512 may push the forward lens assembly 510 toward the rearward bias device 514, the rearward lens assembly 508, or both. The forward bias device 512 may pull the forward lens assembly 510 towards the rearward bias device 514, the rearward lens assembly 508, or both. The forward bias device 512, the rearward bias device 514, or both may be or include a polymer, metal, plastic, rubber, an elastomer, a magnetic material, a ferrous metal, iron, cobalt, nickel, a rare earth metal, Alnico, ceramic magnets, or a combination thereof. The rare earth metals may be neodymium, samarium cobalt, or both. The forward bias device 512 may have a first magnetic material with a first magnetism (e.g., positive) and the rearward bias device 514 may have a second magnetic material with a second magnetism (e.g., negative).

The first magnetism and the second magnetism may be opposite so that the forward bias device 512 and the rearward bias device 514 are attracted. The first magnetic materials may be a magnet and the second magnetic material may be a material that the magnet is attracted. The first magnetism and the second magnetism may be sufficiently strong to move the forward lens assembly 510 into communication with the rearward lens assembly 508. The magnetism between the forward bias device 512 and the rearward bias device 514 may be sufficiently high to maintain a connection between the forward lens assembly 510 and the rearward lens assembly 508 during normal use. Normal use may be capturing images, holding the image capture device, changing orientation of the image capture device, facing the image capture device downward, walking, running, performing a sport, or a combination thereof. The magnetic connection between the forward bias device 512 and the rearward bias device 514 may be broken if a shock is applied to the optical system 500, or the image capture device 100, 200 housing the optical system 500. Thus, for example, during normal use such as moving and playing a sport the forward bias device 512 and the rearward bias device 514 are maintained in contact, but if a shock is applied to the image capture device 100, 200 or the lens module 502 a bias force of the forward bias device 512 and the rearward bias device 514 may be overcome so that the forward lens assembly 510 moves relative to the rearward lens assembly 508.

The forward lens assembly 510 may only be in communication with the rearward lens assembly 508. The forward lens assembly 510 may be free of any direct connection or direct contact with the lens module 502, an outer lens of the lens module 502, a body of the image capture device 100, 200, or a combination thereof. During a shock event, the magnetism (e.g., magnetic force) between the forward bias device 512 and the rearward bias device 514 may be broken temporarily so that the forward lens assembly 510 moves relative to the rearward lens assembly 508, the lens module 502, or both. The forward lens assembly 510 and the rearward lens assembly 508 may have a barrel to barrel interface. The barrel to barrel interface may be temporarily broken by the forward lens assembly 510 floating relative to the rearward lens assembly 508.

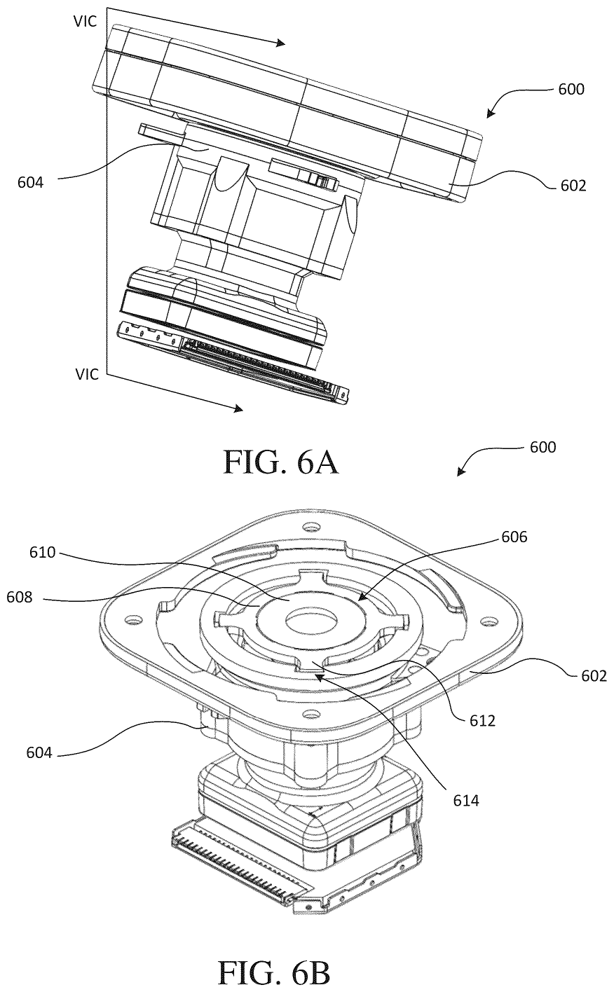

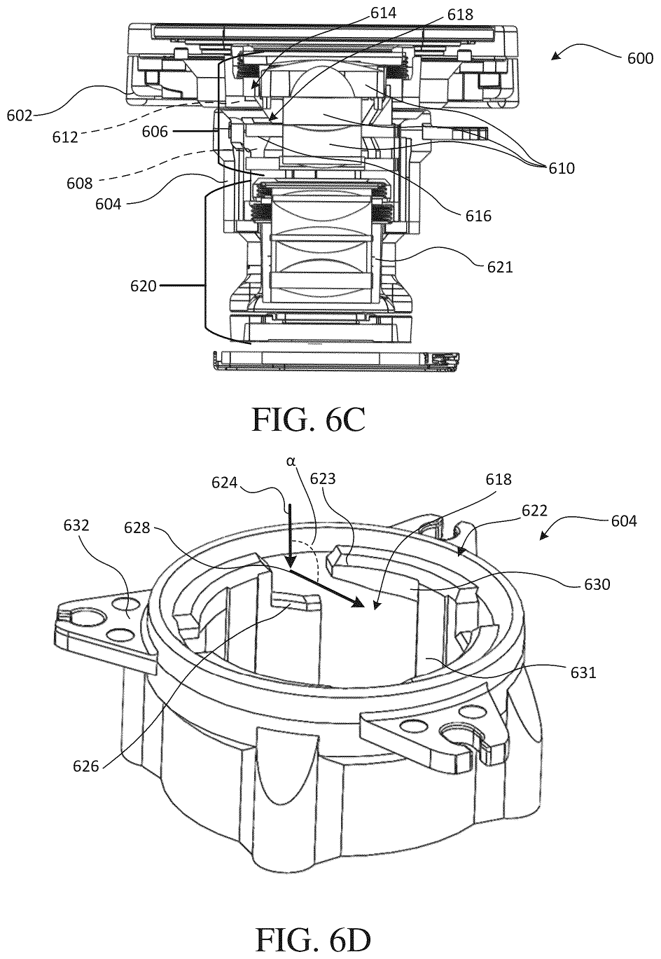

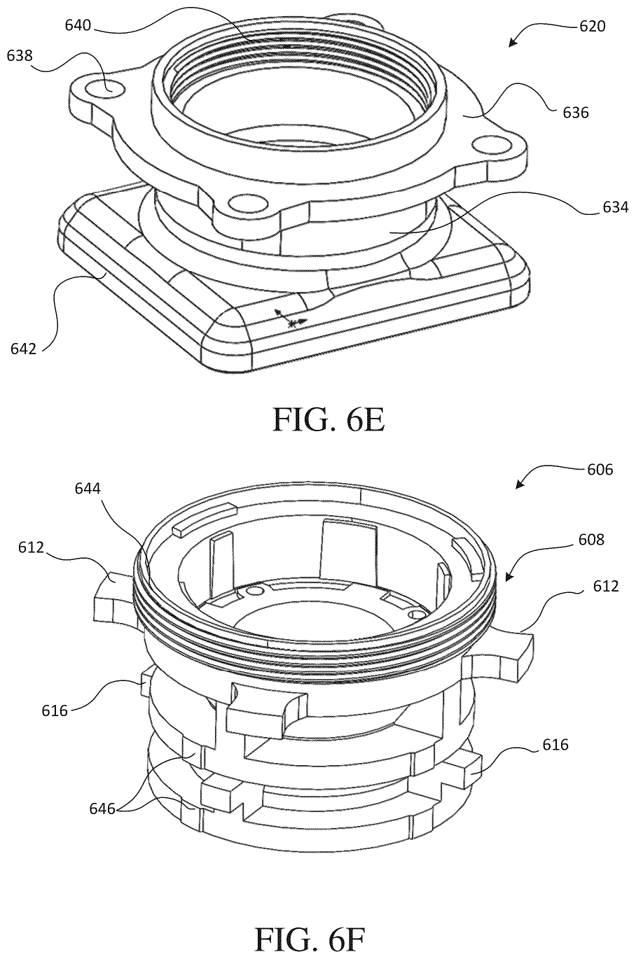

FIG. 6A is a bottom isometric view of the optical system 600. The optical system 600 includes a lens module 602 that is connected within the optical system 600 by a connector 604. The connector 604 may form a removable connection with the lens module 602 so that the lens module 602 may be removed and/or replaced. The connector 604 may also be a forward coupling connector as discussed herein.

FIG. 6B is a top isometric view of the optical system 600 with an outer lens of the lens module 602 removed and an interior of the lens module 602 exposed. The lens module 602 is connected within the optical system 600 by a connector 604. A forward lens assembly 606 is located between and connected to the lens module 602 and the connector 604.

The forward lens assembly 606 includes a forward housing 608 that holds lenses 610 of the forward lens assembly 606. The forward housing 608 may be a rigid part of the forward lens assembly 606 that houses lenses 610. The lenses 610 assist in capturing images via the optical system 600. The forward housing 608 may connect the forward lens assembly 606 to the lens module 602 at a forward end of the forward lens assembly 606. The forward housing 608 may connect the forward lens assembly 606 to the connector 604 at a rear end of the forward lens assembly 606. The forward housing 608 includes locking fingers 612 that extend within locking recesses 614 of the lens module 602 to connect the lens module 602 to the forward lens assembly 606.

The locking fingers 612 may extend outward from the forward housing 608. The locking fingers 612 may extend into one of the locking recesses 614 of the lens module 602. The locking fingers 612 and the locking recesses 614 may be complementary in shape, size, or both. The locking fingers 612 may extend radially outward from the forward housing 608. The locking fingers 612 may be located intermittently around a circumference of the forward housing 608. The locking fingers 612 may be a monolithic part of the forward housing 608. The locking fingers 612 may be spaced apart so that the forward housing 608 includes one or more, two or more, three or more, four or more, ten or less, eight or less, or six or less locking fingers 612. The locking fingers 612 may extend from a top half or above of the forward housing. The locking fingers 612 may be located in a top quarter or above, a top eighth or above, or a very top (e.g., an edge) of the forward housing 608. The locking fingers 612 may extend into the locking recesses 614 as the lens module 602 extends over forward housing 608 of the forward lens assembly 606.

The locking recesses 614 may form a removable connection between the lens module 602 and the forward lens assembly 606. The locking recesses 614 each may have an open area with a portion that extends in a z-direction, a portion that extends in a y-direction, a portion that extends in an x-direction, or a combination thereof so that as then locking fingers 612 extend into the locking recesses 614 the lens module 602 is rotated to lock the lens module 602 to the forward lens assembly 606. The locking recesses 614 and locking fingers 612 may resist removal by applying only an axial force to the lens module 602. For example, the locking fingers 612 may partially elastically deform when extending into the locking recess 614 so that an axial force is applied to the locking fingers 612. The locking recesses 614 may be clocking surfaces that the locking fingers 612 slide along to create a secure connection between the lens module 602 and the forward lens assembly 606. The connection between the lens module 602 and the forward lens assembly 606 may have a spring force that maintains the lens module 602 and the forward lens assembly 606 in contact. The forward lens assembly 606 may be located between and connected to the connector 604 and the lens module 602.

FIG. 6C is a cross sectional view of the optical system 600 of FIG. 6A along line VIC-VIC. The connection discussed in FIG. 6A includes the lens module 602 connected to the forward lens assembly 606 and the forward lens assembly 606 connected to the connector 604. These connections are shown in more detail in the cross-sectional view of FIG. 6C to show further details of those connections.

The forward lens assembly 606 includes the forward housing 608 that contains the lenses 610. The forward housing 608 includes the locking fingers 612 that extend into the locking recesses 614 so that the lens module 602 is connected to the forward lens assembly 606 at a top portion of the forward lens assembly 606. The forward lens assembly 606 includes connector fingers 616 in a bottom region of the forward housing 608 that form a connection when a rear end of the forward lens assembly 606 extends into the connector 604.

The connector fingers 616 are substantially identical to the locking fingers 612. The connector fingers 616 connect the forward lens assembly 606 to the connector 604. The connector fingers 616 may be one or more connector fingers 616, two or more connector fingers 616, or three or more connector fingers 616. The connector fingers 616 may be a monolithic part of the forward housing 608. The connector fingers 616 may be aligned with the locking fingers 612 in a direction along the optical axis. The connector fingers 616 may be offset relative to the locking fingers 612. Thus, the connector fingers 616 and the locking fingers 612 may not be aligned in a direction along the optical axis. The connector fingers 616 may extend into connector recesses 618 within the connector 604 so that the forward lens assembly 606 and rearward lens assembly 620 are aligned relative to one another.

The connector recesses 618 may each receive one of the connector fingers 616 so that the connector recesses 618 and the connector fingers 616 form a fixed connection. The connector recesses 618 may allow the connector fingers 616 to float so that the forward lens assembly 606 may have some movement relative to the rearward lens assembly 620. The rearward lens assembly 620 includes rear lenses 621. The connector recesses 618 may guide the locking fingers 612 axially along the optical axis. Both the locking recesses 614 and the connector recesses 618 may extend in a same direction to form a connection, release a connection, or both. For example, both may be connected by moving in a same direction. The locking recesses 614 may extend in a first direction and the connector recesses 618 may extend in a second direction, which is an opposite direction of the first direction. For example, the locking recess may be a forward lock (e.g., rotated in a first direction to lock) and the connector recess 618 may be a reverse lock (e.g., rotated in a second direction to lock). The connector recess 618 and the connector fingers 616 may form a locked connection.

FIG. 6D is an isometric view of the connector 604 isolated from the optical system 600 of FIGS. 6A-6C. The connector 604 includes the connector recess 618 that as shown is open along an optical axis of the optical system 600. The connector recess 618 is configured to receive a portion of the forward lens assembly 606 of FIGS. 6A-6C. The connector recess 618 includes a locking system 622 that include guides 623 that assist in forming a connection.

The guides 623 may be formed in a wall of the connector 604. The guides 623 may extend into the connector recess 618 from a wall of the connector 604. The guides 623 may be an extension of the wall. The guides 623 may be a monolithic part of the connector 604. The guides 623 may extend radially around the wall of the connector 604, axially along the wall of the connector 604, or both. For example, as the guides 623 extend along a wall of the connector 604, the guide 623 may extend along the optical axis of the connector 604. The guides 623 may assist a user in seating the forward lens assembly 606 within the optical system 600 and relative to the rearward lens assembly 620. The guides 623 may assist in connecting a forward lens assembly 606 to the connector 604. The guides 623 may allow the forward lens assembly 606 to float within the optical system 600. The guides 623 may assist in moving the forward lens assembly 606 along the optical axis. The guides 623 may be tapered so that the forward lens assembly 606 gradually moves axially as the forward lens assembly 606 is rotated relative to the connector 604 and about the optical axis. The guides 623 may extend at an angle so that the connector fingers 616 first move along the longitudinal axis (e.g., the optical axis) in a first locking direction 624 and then rotationally about the optical axis in a second locking direction 636.

The first locking direction 624 may extend only in a single direction or along a single axis. The first locking direction 624 may be parallel to the longitudinal axis or the optical axis. The first locking direction 624 may move in two directions simultaneously. The first locking direction 624 may be constrained only along a first axis, free of movement along a second axis, or both. The first locking direction 624 may be in a straight line. The first locking direction 624 may terminate at a guide stop 626 of the locking system 622.

The guide stops 626 may prevent the connector fingers 616 from continuing to extend in the first locking direction 624. The guide stops 626 may provide an indication to a user that movement in the first locking direction 624 is complete. Once movement in the first locking direction 624 is complete movement in a second locking direction 628 may begin.

The second locking direction 628 may be a rotational movement, axial movement, or a combination of both. The second locking direction 628 may extend along a first axis and a second axis. For example, the second locking direction 628 may extend at least partially along the optical axis (e.g., z-direction) and a rotational component around the optical axis (e.g., along an x-direction, a y-direction, or both). The second locking direction 628 may extend downward and rotate simultaneously. The second locking direction 628 may extend at an angle (a) relative to the first locking direction 624. The angle may be about 90 degrees or more, about 105 degrees or more, or about 115 degrees or more. The angle may be about 175 degrees or less, about 160 degrees or less, about 145 degrees or less, about 130 degrees or less, or about 125 degrees or less. The second locking direction 628 may rotationally seat the forward lens assembly 606 within the connector 604 and then lock or seat the forward lens assembly 606 at a guide lock 630 of the locking system 622.

The guide lock 630 may be a portion of the guide 623 that prevents axial movement, rotational movement, or both. The guide lock 630 may restrict rotational movement of the connector fingers 616, the forward lens assembly 606, or both. The guide lock 630 may permit axial movement of the forward lens assembly 606 while restricting rotational movement. The guide lock 630 may be a lip, a detent, an angle change, a recess, or a combination thereof. In one example, the guide 623 may extend axially downward and then turn in an opposite direction to form the guide lock 630. The guide lock 630 may release the connector fingers 616, the forward lens assembly 606 or both by the forward lens assembly 606 moving in a rearward direction away from the guide lock 630 and then rotating the forward lens assembly 606 in a direction opposite an installation direction. (e.g., opposite the second locking direction 628). The guide lock 630 may allow the forward lens assembly 606 to float. When the guide lock 630 is engaged by the locking fingers 612 alignment surfaces 631 may be contacted.

The alignment surfaces 631 may be a surface that assists in aligning the forward lens assembly 606 and the connector 64. The alignment surfaces 631 may be a flat portion of a guide. The alignment surfaces 631 may be a part of an interior of the connector 604. The alignment surfaces 631 may be equally spaced apart. The alignment surfaces 631 may be located in quadrants. The alignment surfaces 631 may be a raised surface. The alignment surfaces 631 may form a friction fit when the forward lens assembly 606 fully extends into the connector 604. The alignment surfaces 631 may form a connection when the forward lens assembly 606 is rotated the connector 604. The alignment surfaces 631 may align the forward lens assembly 606 within the connector 604 and the connector 604 may include connecting arms 632.

The connecting arms 632 may receive one or more fasteners (not shown) that connect the connector 604 to the lens module 602 or a body of an image capture device 100, 200. The connecting arms 632 may fix the connector 604 inside of an image capture device. The connecting arms 632 may connect the connector 604 so that the connector 604 extends cantilever from a surface (e.g., a forward wall of an image capture device 100 or 200). The connecting arms 632 may each receive a fastener.

FIG. 6E is an isometric view of the rearward lens assembly 620. The rear lenses 621, shown in FIG. 6C, are removed from the rearward lens assembly 620. The rearward lens assembly 620 includes a rearward housing 634. The rearward housing 634 functions to connect the rear lenses 621 to the connector 604 and maintain the rear lenses 621 along the optical axis. The rearward housing 634 houses all or a portion of the rear lenses 621. The rearward housing 634 may protect the rear lenses 621. The rearward housing 634 includes a connector arm 636.

The connector arm 636 connects the rearward housing 634 to the connector 604. The connector arm 636 may axially align the rearward housing 634 with the connector 604. The connector arm 636 may be planar, extend within a plane, or both. The connector arm 636 may extend radially outward from a cylindrical wall of the rearward housing 634. The connector arm 636 may be complementary in shape to a rear end of the connector 604. The connector arm 636 may seat with the rear end of the connector 604 so that the forward lens assembly 606 and the connector 604 are axially aligned relative to one another along an optical axis. The connector arm 636 may form a fixed connection with the connector 604. The connector arm 636 may include arm recesses 638.

The arm recesses 638 may be an aperture that extends through the connector arm 636. The arm recesses 638 may receive fasteners (not shown) that connect the connector arm 636 and the connector 604 together. The arm recesses 638 may be spaced apart around the connector arm 636. The connector arm 636 may include two arm recesses 638 or more, three arm recesses 638 or more, four arm recesses 638 or more, or eight arm recesses 638 or less. The arm recesses 638 may be equally spaced apart. The arm recesses 638 may connect the rearward housing 634 so that the rearward housing 634 and the rear lenses 621 within the rearward housing 634 are axially aligned with the connector 604.

The rearward housing 634 includes a lens connector 640. The lens connector 640 receives all or a portion of the rear lenses 621. The lens connector 640 may fixedly connect the rear lenses 621 to the rearward housing 634. The lens connector 640 may be co-axial with the optical axis. The lens connector 640 may be annular. The lens connector 640 may be threads, a press fit connection, a mechanical connection, a chemical connection, an adhesive, or a combination thereof. The lens connector 640 may be located on an opposite side of the rearward housing 634 a sensor connector 642.

The sensor connector 642 connects the integrated sensor 506 to a rearward end of the optical system 600. The sensor connector 642 may align the integrated sensor 506 with the optical axis of the optical system 500. The sensor connector 642 may connect the integrated sensor to a rear end of the rearward housing 634 and the optical system 600.

FIG. 6F is an isometric view of the forward lens assembly 606. The forward lens assembly 606 houses the lenses 610 of FIGS. 6B-6C, which as shown are removed from the forward housing 608. The forward housing 608 connects the forward lens assembly 606 and lenses 610 within the optical system 600 and especially the connector 604. The forward housing 608 may align the lenses 610 along the optical axis so that when the forward housing 608 is connected to the connector 604 the optical axis extends through the forward housing 608, the connector 604, and the optical system 600. The forward lens assembly 606 includes the locking fingers 612 and the connector fingers 616.

The locking fingers 612, the connector fingers 616, or both may extend radially outward from the forward housing 608. The locking fingers 612 may be located near a top of the forward housing 608. The connector fingers 616 may be located near a bottom of the forward housing 608. The locking fingers 612, the connector fingers 616, or both may connect the forward housing 608 to another component of the optical system 600. The locking fingers 612 may be larger than the connector fingers 616 or vice versa. The locking fingers 612 may be axially offset relative to the connector fingers 616. The locking fingers 612, the connector fingers 616, or both may form a fixed connection by axially extending into a corresponding recess (e.g., a locking recess 614 or connector recess 618 respectively), radially extending into a corresponding recess, or both. The locking fingers 612 may connect the forward housing 608 to the lens module 602. The connector fingers 616 may connect the forward housing 608 to a connector 604. The locking fingers 612 and connector fingers 616 may be located axially rearward of a forward lens connector 644.

The forward lens connector 644 may connect a lens to an upper region or a top of the forward housing 608. The forward lens connector 644 may removably connect a lens to the forward housing 608. The forward lens connector 644 may be threads that removably connect a lens to the forward housing. The forward lens connector 644 may be aligned along an optical axis so that the forward lens assembly 606 and lens module 602 connect to one another and/or are aligned. The forward lens assembly 606 may be aligned along the optical axis by one or more alignment tab 646 centering the forward lens assembly 606 relative to the connector 604 of FIG. 6D.

The alignment tab 646 function to center the connector 604 along an optical axis. The alignment tab 646 may center the forward lens assembly 606 within the connector 604. The alignment tab 646 may rotate into contact with the alignment surface 631. The alignment tab 646 and the alignment surface 631 may create a friction fit. The alignment tabs 646 may align with the alignment surfaces 631 when the locking fingers 612 are fully seated within the guide 623 or aligned relative to the guide 623. The alignment tabs 646 may project outward from a surface of the connector 604. The alignment tabs 646 align with the alignment surfaces 631 of FIG. 6D. The alignment tabs 646 may be equally spaced apart. Multiple alignment tabs 646 may contact each alignment surface 631. The alignment tabs 646 may be axially aligned with one another, radially aligned with one another, or both. The alignment tabs 646 may generate a friction force to prevent movement of the forward lens assembly 606 relative to the connector 604. The alignment tabs 646 may have an end surface or contact surface that is flat, rounded, arcuate, dished, of complementary in shape with the alignment surfaces 631. As the locking fingers 612 are rotated within the locking system 622 the alignment tabs 646 are rotated into contact with the alignment surfaces 631 to align the forward lens assembly 606 relative to the connector 604 as the locking fingers 612 contact the guide lock 630.

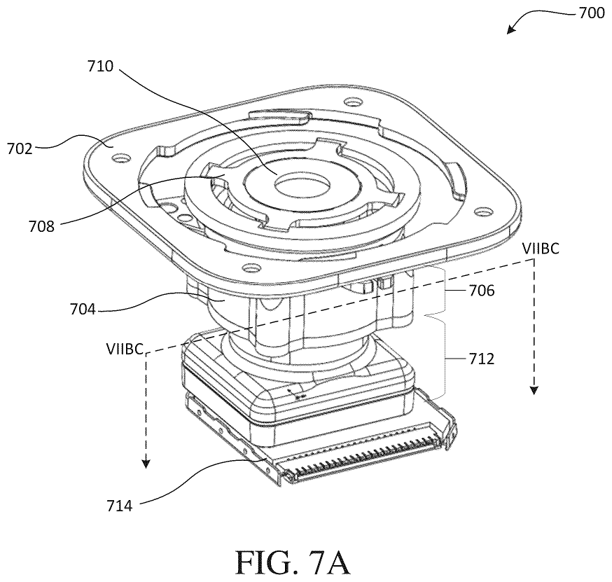

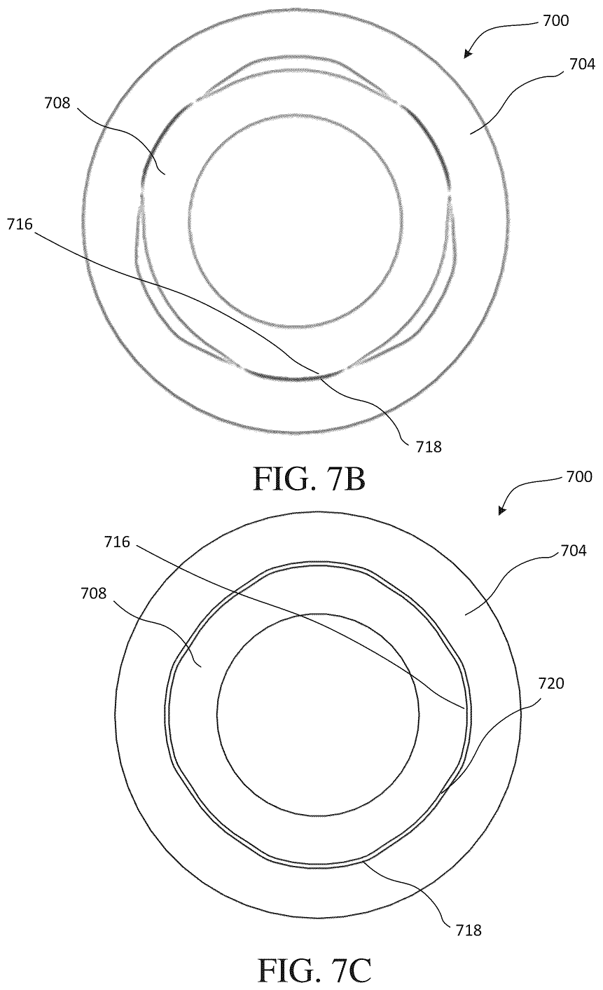

FIG. 7A is an isometric view of an optical system 700. The optical system 700 has a lens module 702 located at a top of the optical system 700. The lens module 702 has an outer lens removed so that an interior of the lens module 702 is visible. The connection of the lens module 702 of FIG. 7A is the same as the connection of the lens module 602 of FIG. 6B. The lens module 702 is in communication with a connector 704. The connector 704 encloses a forward lens assembly 706. The forward lens assembly 706 includes a forward housing 708 and lenses 710. The forward housing 708 is aligned with a rearward lens assembly 712 by a connection between the connector 704 and the rearward lens assembly 712. As shown, a forward end of the rearward lens assembly 712 is connected to the connector 704 and a rear end of the rearward lens assembly 712 is connected to an image sensor 714.

FIG. 7B is a cross-sectional view of the optical system 700 along line VIIBC-VIIBC. As shown, the optical system 700 includes the connector 704 in a locked position with the forward housing 708. In the locked position, a clocking surface 716 of the forward housing 708 is rotated into contact with a compression alignment surface 718 of the connector 704.

The clocking surfaces 716 are lobes on an outer surface of the forward housing 708. The clocking surfaces 716 are an outward protrusion of the forward housing 708. The clocking surfaces 716 may be axisymmetric, non-axisymmetric, equally spaced apart, unevenly spaced apart, or a combination thereof. The forward housing 708 may include one clocking surface 716 or more, two clocking surfaces 716 or more, three clocking surfaces 716 or more, or four clocking surfaces 716 or more. The forward housing 708 may include eight clocking surfaces 716 or less, six clocking surfaces 716 or less, or five clocking surfaces 716 or less. The clocking surfaces 716 may be rigid or made of a rigid material. The clocking surfaces 716 may be made of or include an elastomerically deformable material, a compressible material, rubber, an elastomer, a polymer, plastic, metal, a coated metal, or a combination thereof. The clocking surfaces 716 may extend into contact with the compression alignment surfaces 718 such that once the connector 704 and the forward housing 708 are in the locked position a predetermined amount of force holds the connector 704 and the forward housing 708 in contact, a predetermined amount of force is needed to move the connector 704 and the forward housing 708 relative to one another.

The predetermined amount of force may be a sufficient force to prevent accidental movement, vibrational movement, or both of the connector 704 relative to the forward housing 708. The predetermined amount of force may be created by deformation of the connector 704 and the forward housing 708. The predetermined amount of force may be generated by material properties generating friction between the connector 704 and the forward housing 708. The predetermined amount of force may be generated based upon controlled tolerances between the connector 704 and the forward housing 708. The predetermined amount of force may be about 5 N or more, about 10 N or more, about 15 N or more, about 20 N or more, about 25 N or more, or about 30 N or more. The predetermined amount of force may be about 100 N or less, about 90 N or less, about 80 N or less, or about 70 N or less. The predetermined amount of force may be generated by the clocking surfaces 716 being moved into contact with the compression alignment surfaces 718.

The compression alignment surfaces 718 are lobes or bumps on an inner surface of the connector 704. The compression alignment surfaces 718 may be complementary in shape and/or size to the clocking surfaces 716. The compression alignment surfaces 718 are a protrusion of the connector 704 extending inward towards an optical axis of the optical system 700. The compression alignment surfaces 718 may be axisymmetric, non-axisymmetric, equally spaced apart, unevenly spaced apart, or a combination thereof. The connector 704 may include one compression alignment surfaces 718 or more, two compression alignment surfaces 718 or more, three compression alignment surfaces 718 or more, or four compression alignment surfaces 718 or more. The connector 704 may include eight compression alignment surfaces 718 or less, six compression alignment surfaces 718 or less, or five compression alignment surfaces 718 or less. The number of the clocking surfaces 716 and the number of the compression alignment surfaces 718 may be equal. The compression alignment surfaces 718 may be rigid or made of a rigid material. The compression alignment surfaces 718 may be made of or include an elastomerically deformable material, a compressible material, rubber, an elastomer, a polymer, plastic, metal, a coated metal, or a combination thereof. The compression alignment surfaces 718 and the clocking surfaces 716 may be made of a same material or a different material. The compression alignment surfaces 718 may extend into contact with the clocking surfaces 716 such that once the connector 704 and the forward housing 708 are in the locked position a predetermined amount of force holds the connector 704 and the forward housing 708 in contact, a predetermined amount of force is needed to move the connector 704 and the forward housing 708 relative to one another.

FIG. 7C is a cross-sectional view of the optical system 700 of FIG. 7A along line VIIBC. The optical system 700 is in an unlocked position. In the unlocked position, the clocking surfaces 716 of the forward housing 708 are spaced apart from the compression alignment surfaces 718 of the connector 704. The spacing of the clocking surfaces 716 relative to the compression alignment surfaces 718 forms a gap 720 between the connector 704 and the forward housing 708.

The gap 720 between the connector 704 and the forward housing 708 permits the forward housing 708 to move along the optical axis of the optical system 700, to be removed from the connector 704, to be replaced, or a combination thereof. The gap 720 may be present when the clocking surfaces 716 and the compression alignment surfaces 718 are free of contact.

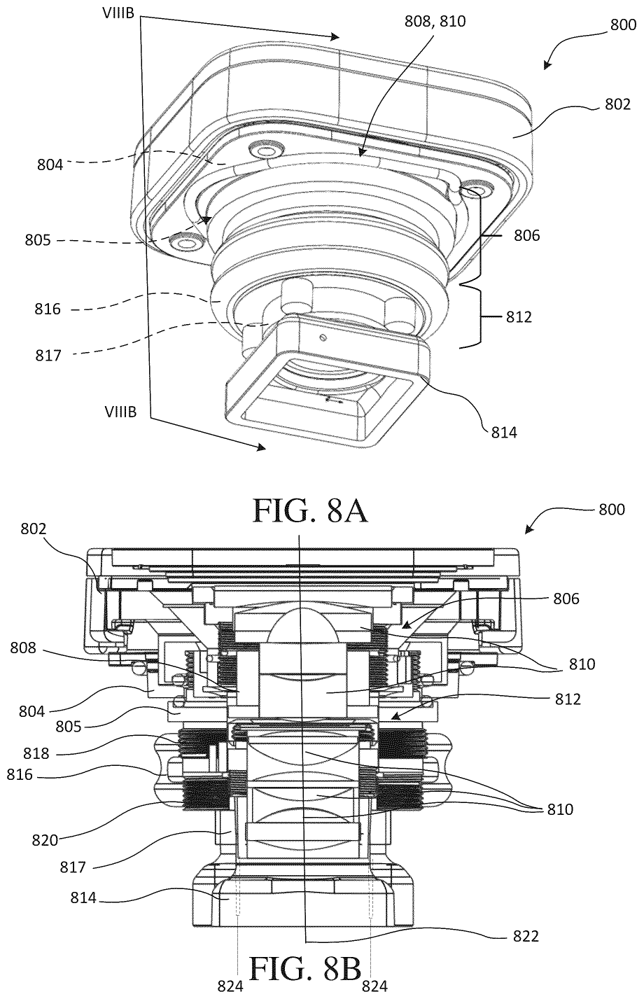

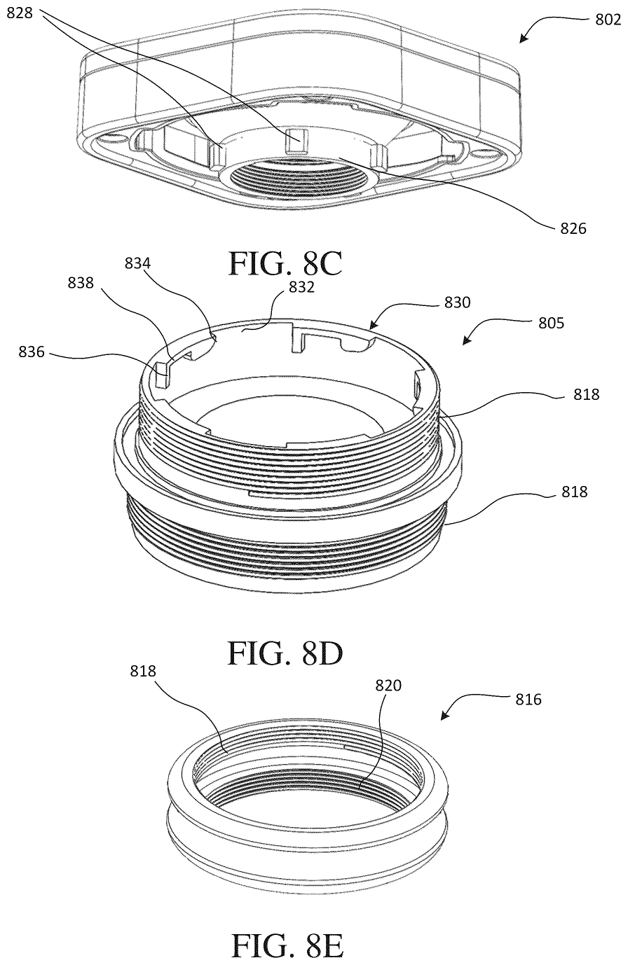

FIG. 8A is an isometric view of an optical system 800. The optical system 800 includes a lens module 802 that forms a forward most portion of the optical system 800. The lens module 802 is connected to a connector 804. The connector 804 extends between and is connected to a forward coupling connector 805 and the lens module 802. The connector 804 and the forward coupling connector 805 are located axially forward of a forward lens assembly 806. The forward lens assembly 806 includes a forward housing 808 and lenses 810 that are located within the forward lens assembly 806. The forward lens assembly 806 is axially aligned with the rearward lens assembly 812. The rearward lens assembly 812 is connected to the forward lens assembly 806 at a front end and the rearward lens assembly 812 is connected to an image sensor 814 at a rear end. The forward lens assembly 806 and the rearward lens assembly 812 are connected together by a union 816. The forward coupling connector 805 extends along all or a portion of the forward lens assembly 806 and at least a portion of the rearward lens assembly 812. A rearward coupling connector 817 extends along all or a portion of the rearward lens assembly 812. The union 816 connects to the forward coupling connector 805 and the rearward coupling connector 817.

The union 816 functions to connect, align, hold, protect, or a combination thereof the forward lens assembly 806 and the rearward lens assembly 812 relative to one another. As shown, the union 816 forms an indirect connection with the forward lens assembly 806 and the rearward lens assembly 812 through the forward coupling connector 805 and the rearward coupling connector 817 respectively. The union 816 may directly connect to the forward lens assembly 806 and the rearward lens assembly 812. The union 816 may concentrically align the forward lens assembly 806 and the rearward lens assembly 812. The union 816 may form a fixed connection by threaded members, detents, press fit, snap and lock, fasteners, a friction fit, or a combination thereof. A portion of the union 816 may be right hand threaded and a portion of the union 816 may be left hand threaded. The union 816 may be located on an exterior of the forward lens assembly 806 and the rearward lens assembly 812. The union 816 may be located on an exterior of the forward coupling connector 805 and the rearward coupling connector 817. The union 816 and forward lens assembly 806 and/or forward coupling connector 805 may be right hand threaded or left hand threaded. The union 816 and the rearward lens assembly 812 and/or rearward coupling connector 817 may be right hand threaded or left hand threaded. The forward lens assembly 806 and rearward lens assembly 812 may be opposite threaded.

FIG. 8B is a cross-sectional view of the optical system 800 of FIG. 8A along line VIIIB-VIIIB. A connection between the lens module 802 and the connector 804 are visible. The connection between the lens module 802 and the forward lens assembly 806 are visible. These connections are shown as threaded connections; however, other types of connections taught herein may be used. The forward lens assembly 806 includes a forward housing 808 that houses the lenses 810.

The rearward lens assembly 812 is located behind (rear of) the forward lens assembly 806. The rearward lens assembly 812 includes lenses 810. The rearward lens assembly 812 is connected to the image sensor 814 so that the lenses 810 and the image sensor 814 are aligned. A union 816 connects the forward lens assembly 806 and the rearward lens assembly 812 (e.g., indirectly). The union 816 is directly connected to the forward coupling connector 805 and the rearward coupling connector 817.

The union 816 is connected at a forward end of the rearward lens assembly 812 and at a rearward end of the forward lens assembly 806. The union 816 may be in communication with the forward lens assembly 806 via a forward connector 818. The union 816 is in direct communication with the forward coupling connector 805 and the rearward coupling connector 817. The union 816 may be in communication with the rearward coupling connector 817 at a rearward connector 820. The union 816 may be an annular ring. The union 816 may have a generally “C” cross-sectional shape. The union 816 may prevent movement of the forward lens assembly 806, the rearward lens assembly 812, or both along an optical axis 822 (e.g., along a z-axis) of the optical system 800. The union 816 may connect to the forward connector 818 so that the forward lens assembly 806 is prevented from moving along the optical axis 822, the union may connect with the rearward connector 820 so that the rearward lens assembly 812 is prevented from moving along the optical axis 822, or both. The union 816 and a connection with the forward connector 818 of the forward coupling connector 805 may allow movement of the forward lens assembly 806 about the optical axis 822 (e.g., along an x-axis, a y-axis, or both). For example, a radial space may be present between the forward coupling connector 805 and the forward lens assembly 806 so that the forward lens assembly 806 may move relative to the forward coupling connector 805, the optical axis 822, or both (e.g., along an x-axis, a y-axis, or both). A circumferential gap 824 is located between the forward coupling connector 805 and the forward lens assembly 806 and the rearward coupling connector 817 and the rearward lens assembly 812.

The gap 824 permits movement about the optical axis 822. The gap 824 may permit movement in a direction perpendicular to the z-axis. The perpendicular direction may be long the x-axis, the y-axis, or a direction therebetween. The gap 824 may permit the rearward lens assembly 812 to float relative to the rearward coupling connector 817. The gap may permit the forward lens assembly 806 to float relative to the forward coupling connector 805. The gap 824 may be about 0.1 mm or more, 0.2 mm or more, 0.3 mm or more, or about 0.5 mm or more. The gap 824 may be about 5 mm or less, about 4 mm or less, about 3 mm or less, about 2 mm or less, or about 1 mm or less. The gap 824 may permit movement relative to the optical axis 822 so that the optical system 800 absorbs shock or a force without being damaged. For example, a forward lens assembly 806 may move to absorb the shock and then elastically move back into place.

The union 816 and a connection with the rearward connector 820 of the rearward coupling connector 817 may allow movement of the rearward lens assembly 812 about the optical axis 822 (e.g., along an x-axis, a y-axis, or an axis therebetween). The union 816 may permit some floating from side to side relative to the optical axis 822 of the forward lens assembly 806, the rearward lens assembly 812, or both. The union 816 may maintain optical alignment of the lens module 802, the forward coupling connector 805, the forward lens assembly 806, the rearward lens assembly 812, the image sensor 814, the rearward coupling connector 817, or a combination thereof. The union 816 may maintain optical alignment if there is a force applied to the optical system 800, a blunt force applied to the optical system 800, or both. For example, if the optical system 800 or an image capture device including the optical system 800 is dropped, the optical system 800 may move to absorb the impact and then move back to restore the optical axis 822. The union 816 may allow the forward lens assembly 806 to move within a plane relative to the rearward lens assembly 812. For example, the forward lens assembly 806 may move along the x-axis, y-axis, or both relative to the rearward lens assembly 812 or vice versa while being prevented from moving in along the z-axis or optical axis 822.

FIG. 8C is a bottom isometric view of the lens module 802. The lens module 802 includes a lens module connector 826 that permits the lens module 802 to be added and removed from the optical system 800 of FIGS. 8A-8B. The lens module connector 826 may form a connection with the forward lens assembly 806 shown in FIG. 8B. The lens module connector 826 as shown is a threaded connection or helical threads. The lens module connector 826 may form a different connection such as another connection taught herein. The lens module connector 826 may be a twist and lock connection, a detented connection, a press fit connection, a friction fit connection, a snap fit connection, a connection with a bias device, a connection with a pin, or a combination thereof. The lens module connector 826 may form any type of connection where the connection may be made and removed without disassembling any other part of the optical system 800 or an image capture device housing the optical system 800. The lens module connector 826 includes locking fingers 828 on an exterior.

The locking fingers 828 may be projections that extend outward from an exterior of the lens module connector 826. The locking fingers 828 may be equally spaced apart. The locking fingers 828 may be randomly spaced. The locking fingers 828 may be virtually any shape. The locking fingers 828 may be round, square, rectangular, geometric, non-geometric, symmetrical, non-symmetrical, or a combination thereof. The locking fingers 828 include one or more flat walls, two or more flat walls, three or more flat walls, three or more flat walls, or four or more flat walls. The locking fingers 828 extend as sufficient distance to connect with another component of the optical system 800. The locking fingers 828 may extend a distance of about 0.2 mm or more, about 0.4 mm or more, about 0.6 mm or more, about 0.8 mm or more, or about 1 mm or more. The locking fingers may extend a distance of about 1 cm or less, about 7 mm or less, about 5 mm or less, or about 3 mm or less.

FIG. 8D is an isometric view of a forward coupling connector 805. The forward coupling connector 805 includes forward connectors 818. One forward connector 818 is located at a top of the forward coupling connector 805 and a second forward coupling connector 818 located at a bottom of the forward coupling connector 805. The forward connector 818 at the top connects to the connector 804 of FIG. 8B. The lens module 802 connects to the forward connector 818 via the connector 804. The forward connector 818 at the bottom connects to the union 816 shown in FIG. 8B. The forward coupling connector 805 is connected via the forward connector 818 at the bottom and the forward connector 818 at the top an includes a locking system 830 that extends through a central region of the forward coupling connector 805.

The locking system 830 includes an insertion portion 832, rotation portion 834, a stopping portion 836, and a locking portion 838. The locking system 830 removably connects a forward lens assembly 806 of FIG. 8B within the optical system 802. The forward lens assembly 806 connects within the optical system 800 via the locking system 830 of the forward coupling connector 805. The locking system 830 includes insertion portions 832.

The insertion portions 832 are an absence of material between portions that extend outward. The insertion portions 832 permit the locking fingers 828 of FIG. 8C to extend into the forward coupling connector 805. The locking fingers 828 may extend in a first locking direction into the insertion portions 832. The insertion portions 832 may be equally spaced apart, randomly spaced apart, or intermittently spaced apart. The insertion portions 832 and the locking fingers 828 may be complementary in shape, size, orientation, separation, or a combination thereof so that the locking fingers 828 may be inserted into and/or removed from the insertion portions 832. The insertion portions 832 may allow the locking fingers 828 to extend axially into and out of the forward coupling connector 805 in an axial direction (e.g., along the optical axis 822). The forward coupling connector 805 may include three or more, four or more, five or more, six or more, or even seven or more insertion portions 832. The forward coupling connector 805 may include about twenty or less, about fifteen or less, or about ten or less insertion portions. Each insertion portion 832 may be separated by a rotation portion 834, a stopping portion 836, and a locking portion 838.

The rotation portions 834 may be a point of first contact for the locking fingers 828. The locking fingers 828 may extend in a second locking direction into contact with and around the rotation portions 834. The rotation portions 834 may rotatably receive the locking fingers 828. The rotation portions 834 may axially move the lens module 802 as the locking fingers 828 are rotated into contact with and along the rotation portions 834. The rotation portions 834 may be blunt, pointed, flat, rounded, bulbous, half arrow shaped, half oval shaped, tapered on a first end, steep on a second end, or a combination thereof. The rotation portion 834 may assist in converting a rotational force into an axial force. For example, as a rotational force is applied to the locking fingers 828, each of the locking fingers 828 contact one of the insertion portions 832, which gradually increases in thickness so that the locking fingers 828 move along the optical axis towards a locked position. The rotation portions 834 may gradually increase in thickness in a rotational direction from a forward end to a tail end of the rotation portions 834. A tail end of the rotation portions 834 may be a thickest part of the rotation portions 834. The tail end of the rotation portions 834 may prevent a locking finger 828 from being rotationally removed from locking system 830. After the locking fingers 828 extend over the tail end of the rotation portions 834, the locking fingers 828 extend between the rotation portions 834 and the stopping portions 836.

The stopping portions 836 prevent over rotation of the locking fingers 828. The stopping portion 836 may operate identically or similarly to the guide stop 626 shown in FIG. 6D. The stopping portions 836 may block movement of the locking fingers 828. The stopping portions 836 may be a wall. The stopping portions 836 may be a wall that extends along the optical axis 822. The stopping portions 836 may be sufficiently long that the locking fingers 828 cannot extend around the stopping portions 836. The stopping portions 836 may form a rear end of the locking system 830. The stopping portions 836 may have a length along the optical axis 822 of about 1 mm or more, about 2 mm or more, or about 3 mm or more. The stopping portions 836 may have a length along the optical axis 822 of about 1 cm or less, about 7 mm or less, or about 5 mm or less. The stopping portions 836 may align the locking fingers 828 with a locking portion 838.

The locking portions 838 are a location between the rotation portion 834 and the stopping portion 836. The locking portions 838 may be a location where the locking fingers 828 are locked, prevented from rotating, seated, or a combination thereof. The locking portions 838 may prevent rotation of the lens module 802 of FIG. 8C relative to the forward coupling connector 805. The locking portions 838 may be a recess or detent where the locking fingers 828 seat so that the lens module 802 is connected to the optical system 800. The locking portions 838 may be a location between two barriers where the locking fingers 828 are retained so that the lens module 802 are prevented from moving axially along the optical axis 822, rotationally around the optical axis 822 or both. The locking portions 838 may have a length that is substantially equal to a length of the locking fingers 828. Thus, once the locking fingers 828 are seated within the locking portions 838 the lens module 802 is prevented from rotating about the optical axis 822. The locking portions 838 may extend perpendicular to the optical axis 822, the stopping portions 836, the rotation portions 834, or a combination thereof.

FIG. 8E is an isometric view of the union 816 of FIG. 8B. An interior of the union 816 includes the forward connector 818 and the rearward connector 820. The forward connector 818 is located axially above the rearward connector 820. The forward connector 818, the rearward connector 820, or both may be threads, snapping features, detents, a lock, or a combination thereof. The forward connector 818, the rearward connector 820, or both may be right hand threaded or left hand threaded. The forward connector 818 may rotate in an opposite direction as the rearward connector 820. The forward connector 818 and the rearward connector 820 may rotate in a same direction. The union 816 may connect two pieces together. The union 816 may act as a bridge between two components. The union 816 may connect the forward lens assembly 806 to the rearward lens assembly 812 as is shown in FIGS. 8A-8B. The union 816 may axially align two components together. The union 816 may be co-axial with the forward lens assembly 806 and the rearward lens assembly 812. The union 816 may prevent any axial movement of the forward lens assembly 806 relative to the rearward lens assembly 812.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device comprising:
an optical system comprising:
a rearward lens assembly;
a forward lens assembly axially aligned with the rearward lens assembly along an optical axis; and
a bias device located between the rearward lens assembly and the forward lens assembly and configured to allow the forward lens assembly to move relative to the rearward lens assembly.

2. The image capture device of claim 1, further comprising:
a lens module located axially forward of the forward lens assembly, wherein the lens module and the forward lens assembly are free of direct contact and the bias device permits movement of the forward lens assembly relative to the lens module.

3. The image capture device of claim 1, wherein the bias device is a spring.

4. The image capture device of claim 3, wherein the spring is a wave washer.

5. The image capture device of claim 1, wherein the bias device is one or more magnets.

6. The image capture device of claim 5, wherein a first of the one or more magnets is in communication with the forward lens assembly and a second of the one or more magnets is in communication with the rearward lens assembly.

7. The image capture device of claim 1, wherein the bias device is a forward bias device and a rearward bias device that located axially opposite one another.

8. An image capture device comprising:
a forward lens assembly comprising two or more connector fingers;
a rearward lens assembly aligned with the forward lens assembly along an optical axis; and
a connector receiving all or a portion of the forward lens assembly and all or a portion of the rearward lens assembly,
wherein the connector comprises two or more guides that align with and are configured to receive the two or more connector fingers so that when the two or more connector fingers are inserted into the two or more guides, the forward lens assembly is removably connected to the connector, and
wherein the forward lens assembly floats within the connector so that the forward lens assembly is movable relative to the rearward lens assembly.

9. The image capture device of claim 8, further comprising:
a lens module disposed axially forward of the forward lens assembly, wherein the forward lens assembly is free of a direct connection with the lens module and floats relative to the lens module.

10. The image capture device of claim 8, wherein the two or more connector fingers extend into the two or more guides in a first locking direction and then extend in a second locking direction to connect the forward lens assembly to the connector.

11. The image capture device of claim 8, wherein the two or more guides include a guide lock that retains the two or more connector fingers within the two or more guides.

12. The image capture device of claim 8, wherein the two or more connector fingers extend radially outward from the connector.

13. The image capture device of claim 8, further comprising:
two or more locking fingers that are configured to connect the forward lens assembly to a lens module.

14. The image capture device of claim 8, further comprising alignment tabs located on an exterior of the forward lens assembly.

15. The image capture device of claim 14, wherein alignment tabs are configured to center the forward lens assembly within the connector.

16. An image capture device comprising:
an optical system comprising:
a forward lens assembly comprising a forward housing having an exterior surface having clocking surfaces; and
a connector that receives all or a portion of the forward lens assembly,
wherein the connector includes an interior surface having compression alignment surfaces that form a locked position when the compression alignment surfaces are aligned with the clocking surfaces to create a friction fit that prevents the forward lens assembly from moving relative to the connector.

17. The image capture device of claim 16, wherein the connector and the forward housing have an unlocked position where the clocking surfaces and the compression alignment surfaces are offset relative to one another and the exterior surface of the forward housing is complementary in shape to the interior surface of the connector.

18. The image capture device of claim 16, wherein the compression alignment surfaces are non-axisymmetric lobes.

19. The image capture device of claim 18, wherein the non-axisymmetric lobes are rotatable into contact with the clocking surfaces to create the friction fit.

20. The image capture device of claim 16, wherein the clocking surfaces and the compression alignment surfaces, in an unlocked position, are aligned so that the connector and the forward housing are movable along an axis with respect to one another.
